(19) United States
(12) Patent Application Publication
(10) Pub. No.: US 2014/0076866 A1
(43) Pub. Date: Mar. 20, 2014

(54) METHOD AND DEVICE FOR JOINING COMPONENTS BY MEANS OF ENERGY BEAM WELDING

(71) Applicants: Mario Gramsch, Wolfsburg (DE); Norbert Weferling, Schwulper (DE)

(72) Inventors: Mario Gramsch, Wolfsburg (DE); Norbert Weferling, Schwulper (DE)

(21) Appl. No.: 14/122,991

(22) PCT Filed: May 14, 2012
(86) PCT No.: PCT/EP2012/002067

§ 371 Date: Nov. 27, 2013

(30) Foreign Application Priority Data
Jun. 3, 2011 (DE) 10 2011 103 246.4

(51) Int. Cl. B23K 26/24; B23K 26/03

(52) U.S. Cl. CPC B23K 26/24; B23K 26/03
USPC 219/121.64; 219/121.63

(57) ABSTRACT

The invention relates to a method for joining a first component (3) to a second component (5) by means of energy beam welding, wherein at least one of the components (3, 5) has a coating that regionally evaporates during the energy beam welding. In order to allow improved joining of the components (3, 5), the method is carried out by positioning the first component (3) and the second component (5) between a first pressure piece (7) and a second pressure piece (9), moving the pressure pieces (7, 9) towards one another and in the process analysing a profile (31) that characterizes a force (33) that occurs between the pressure pieces (7, 9), setting a relative position of the pressure pieces (7, 9) with respect to one another depending on the analysis, joining the components (3, 5) by means of the energy beam welding with the pressure pieces (7, 9) in the set relative position. The invention also relates to a device (1) according to the method for joining the components (3, 5).

The present invention relates to a method and a device for joining a first component to a second component using energy beam welding, at least one of the components having a coating that evaporates in some areas during the energy beam welding.

### BACKGROUND INFORMATION

Joining of components using energy beam welding is known. The energy beam may, for example, include a laser beam which is focused on a surface of one of the components in such a way that melting in some areas and thus welding of the components takes place. It is known that evaporation coating of some areas produces a gas flow, which is purged through a joint gap. The joint gap may be maintained, for example, by an elastic deformation of one of the components, by a spacer situated between the components, and/or by a geometry of corresponding joining members or of the components. It is also known to influence the evaporation of the coating, and therefore the formation of pores or holes in the area of a joint, by dosing the heat energy supplied by the energy beam welding. Document DE 10 2006 035 517 B3 relates to a clamping device for clamping sheet metal plates in a welding device, which includes at least one adjustable clamping lever which is pressed against the sheet metal plates via a pressing piece. Situated between the pressing piece and the clamping lever is a compensating spring element which flexibly supports the pressing piece on the clamping lever. A zinc-degassing gap on the order of 0.2 mm is set. Document DE 100 2004 044 601 A1 relates to a welding device for connecting at least partly overlapping, coated, in particular galvanized metal sheets. To weld the metal sheets, the welding device includes a laser beam that is movable in a direction of welding. The metal sheets are situated laterally next to the laser beam in the welding direction between two clamping elements moving together at approximately a welding feed rate, producing a local deformation in the area of the welding site. This local deformation forms a degassing gap through which gases formed during welding escape. A deformation and therefore a degassing gap are produced simultaneously with the actual welding process. Document DE 10 2006 040 514 A1 relates to a method for producing a double metal sheet structure by welding a first sheet made of metal to at least one second sheet made of metal, both metal sheets preferably being made of steel or a steel alloy, at least one bead being formed in the second metal sheet, the second metal sheet then resting with the arched section on the first bead during welding and welded via a weld seam in the bead base to the first metal sheet. Prior to welding, the double metal sheet structure has a local zero joint gap in the area of the bead. Document DE 102 61 507 A1 provides a method for connecting, via a laser weld, two steel sheets, at least one of which has a coating having a melting point which is lower than that of the steel sheet material, the steel sheets being situated, prior to welding, abutting against one another at an acute angle in the area of the laser weld seam and the laser weld seam being formed as a fillet weld; furthermore, a first steel sheet has a main part and an edge flange transitioning to the main part via a curvature, and a second steel sheet with a butt edge is situated in such a way that the butt edge comes into contact with the first steel sheet in the curvature or at least close to the end of the curvature toward the main part, and, in addition, the fillet weld is formed between the butt edge and the first steel sheet in the curvature or at least close to the end of the curvature toward the main part. Document DE 10 2004 041 502 A1 relates to a lap welding method using beam welding on coated metal sheets, in particular a laser beam welding method for galvanized steel sheets, the coating having a significantly lower melting and vaporization or combustion temperature than the sheet material, and at least one coated opposite surface having a joint gap present in the overlapping region. At least one zero joint gap having mating surfaces that rest against one another in a planar or shape-mating manner is present in the overlapping and welding region, and the respective parameters of the energy beam are varied over time laterally at an excitation frequency in a frequency window around a specific excitation frequency of a vapor capillary formed in the molten pool during the welding operation. It is further known when joining via a screw connection to monitor and/or analyze a tightening torque or a curve of the tightening torque. This may be accomplished, for example, using a torque wrench or an electronic measuring device. Document DE 42 14 354 C2 relates to a method for producing a screw connection between two components, a torque and/or angle of rotation being measured during the screw connecting operation, which ends when a switch-off point describable by measured torque or angle of rotation values is attained, the joining point of the screw connecting operation being determined and the screw-connecting operation continuing until a switch-off point, describable from a pre-definable torque or angle of rotation value, measured from the joining point, is attained

The object of the present invention is to enable improved joining of a first component to a second component using energy beam welding, at least one of the components having a coating that evaporates in some areas during energy beam welding, a defined joint gap being settable in a simple manner and independently of a previously known geometry of the components.

The object is achieved by a method for joining a first component to a second component using energy beam welding, at least one of the components having a coating that evaporates in some areas during the energy beam welding, by positioning the first component and the second component between a first pressure piece and a second pressure piece, moving the pressure pieces toward one another and in the process analyzing a curve which characterizes a force that occurs between the pressure pieces, setting a relative position of the pressure pieces with respect to one another as a function of the analysis, and joining the components using energy beam welding with the pressure pieces in the set relative position. An energy beam used in the energy beam welding may, for example, be a laser beam. The laser beam may include visible light and/or heat radiation. In principle, the energy beam may be any form of focused energy for generating heat at a point of impingement on one of the components. In particular, it may be any form of radiation, in particular electromagnetic radiation, which is focused at the point of impingement or joint of the components. A curve may in particular be understood to mean a measurement curve. In particular, a curve may be understood to mean any arbitrary multi-dimensional, in particular two-dimensional variable that characterizes a force, in particular a curve over time and/or along a path. In particular, it may be a driving force, a current flow, a voltage, a torque, a torque of clamping tongs that feature the pressure pieces, a driving force of a linear drive, a sensor signal, in each case along a path of the pressure pieces and/or over time. The curve may be advantageously analyzed independently of any prior knowledge of a geometry, in particular a thickness, of the first component and of the second component. The analysis of the curve may advantageously be carried out for the purpose of setting the relative position of the pressure pieces relative to each other. A joint gap independent of the geometric characteristics of the first component and of the second component is advantageously formed as a result of the relative position set during the joining of the components. Degassing of the welding joint is made possible via the joint gap specifically set in this way, advantageously without a lowered quality of the joint, for example by setting the joint gap too wide, which would cause the joint to sink, or too small a joint gap, which would mean a degassing that is too weak. Degassing may be advantageously avoided by the presence of a molten pool at the joint. The evaporating coating may, for example, include zinc and/or be made of zinc. Evaporation may be understood to mean a transition from a solid and/or liquid aggregate state to a gaseous state. In particular, evaporation may be caused by heating, thereby creating an elemental zinc vapor. Alternatively and/or in addition, evaporation may also be understood to mean combustion of the coating, the coating being capable of being evaporated prior to oxidation using the available atmospheric oxygen and removed via the combustion gases forming over the joint gap instead of the elemental zinc vapor.

A specific embodiment of the method provides for ascertaining a point of slope change in the curve via analysis and a displacement of the pressure pieces relative to each other by a specific value and, based on a further relative position of the pressure pieces with respect to each other, the point at which the slope of the curve changes. A point of slope change may be understood to mean a point of discontinuity of a first derivative of the curve. Alternatively or in addition, a point of slope change may also be understood to mean a range and/or an interval of the curve at which the first derivative of the curve changes significantly from a first value, for example, a first lower value to a second value, for example, a second higher value. In this case, it is sufficient if the first derivative of the curve before the point of slope change and after the point of slope change has significantly different values on average. The point of slope change of the curve advantageously occurs as the pressure pieces are moved toward one another, the slope change advantageously being capable of being interpreted with the aid of elastomechanical laws. It has been recognized that the point of slope change occurs, for example, when the components begin to make contact. Thus, it is possible in a simple way to measure at which relative position the components first make contact. In the event an elastic deformation of the components occurs if they are moved still closer, conceivably a second point of slope change occurs when the components are in surface-to-surface contact with one another. Using the point of slope change in the curve it is advantageously possible to infer the further relative position of the components with respect to each other, this position corresponding, for example, to a zero joint gap. Based on the further relative position, the pressure pieces may then advantageously be moved apart by the defined value. With knowledge of the further relative position, the relative position of the pressure pieces with respect to each other required for later joining may then be set in a simple manner. The relative position set in this way advantageously results in the desirable defined joint gap.

In one further specific embodiment of the method, the components are positioned onto the respective pressure piece with the aid of vapor pressure from evaporation of the coating that occurs in some areas during the energy beam welding. Initially, the components may be advantageously moved close enough to each other until they make surface-to-surface contact in the area of the joint, that is, with a zero joint gap, this being displayable by the point of slope change in the curve. The pressure pieces are then moved apart again, the components initially remaining immobile due, for example, to force of gravity. The components may, however, advantageously be positioned again onto the corresponding pressure piece due to the occurring vapor pressure, the defined, desirable joint gap being automatically set.

In one further specific embodiment of the method, it is provided that one of the components has a welding flange, the components coming into contact at a bend of the welding flange and thus producing a joint gap between the components opening conically outward from the bend, closing the joint gap by moving the pressure pieces toward each other while the welding flange is semi-elastically deformed, the ascertained point of slope change occurring just as the joint gap closes, and the joint gap is opened by a defined amount by setting the relative position. The joint gap may be advantageously closed against restoring forces of the at least semi-elastic deformation of the welding flange. Accordingly, with the aid of the restoring forces, the joint gap may be advantageously opened by a defined amount by the setting of the relative position. The relative position is set by moving the pressure pieces apart, in particular, by pulling one of the pressure pieces back. In principle, it is conceivable to design just one of the pressure pieces to be movable and the other pressure piece to be permanently fixed. Alternatively and/or in addition, it is conceivable to design both pressure pieces to be movable. Advantageously, with knowledge of the point of slope change, it may be deduced that the joint gap has just closed, that is, there is a zero joint gap. The zero joint gap may be understood to mean that the components abut against one another in a planar or shape-mating manner. Alternatively and/or in addition, it is conceivable that a second point of slope change in the curve is ascertained through analysis, the second point of slope change occurring when the components begin to make contact as they approach the bend.

In a further specific embodiment of the method, the second component is pre-stressed with the aid of a chamfer of the second pressure piece. With the aid of the chamfer it is possible to advantageously produce a defined conical joint gap between the components.

In a further specific embodiment of the method, the curve is ascertained as a force-path-diagram of the pressure pieces. Based on the curve of the force over the path of the pressure pieces, it may be advantageously ascertained when elastomechanical changes of the components situated between the pressure pieces result, for example, when contacts occur, at least semi-elastic deformations begin, for example, a pressing down of the welding flange and/or an at least semi-elastic deformation thereof that occurs when the components are in planar contact.

In a further specific embodiment of the method, it is provided that a second point of slope change is ascertained, which occurs when the components begin to make contact at the bend of the welding flange as they approach each other, and/or two tangents are applied to the curve and/or the point of slope change is ascertained as a point of intersection of the tangents. Advantageously, a first tangent to the curve may be applied between the point of slope change and the second point of slope change, and a second tangent may be applied beyond the point of slope change. Thus, the point of slope change may be advantageously ascertained as the point of intersection of the tangents. Alternatively and/or in addition, the second point of slope change may thus also be ascertained, for example, as the point of intersection of the first tangent with a path axis of the force-path diagram.

In a further specific embodiment of the method, it is provided that the pressure pieces are moved apart by the defined value within at least one interval of the following group: 0.05-0.5 mm, 0.1-0.4 mm, 0.1-0.3 mm, 0.15-0.25 mm, preferably 0.2 mm. Advantageously, in this way the joint gap may be advantageously dimensioned, so the joint does not collapse, yet sufficient degassing of the joint may be achieved, in particular without having to remove the vapor via the molten pool.

In a further specific embodiment of the method, it is provided that a thickness and/or a heat transfer resistance of the first component is/are smaller than a thickness and/or a heat transfer resistance of the second component, when an energy beam is focused on a back side of the first component in order to join the components. The front side of the first component opposite the back side delimits the joint gap and is situated opposite a corresponding front side of the second component. Advantageously, an energy consumption for carrying out the energy beam welding may be reduced due to the reduced thickness and/or the reduced heat transfer resistance of the first component. Advantageously, less material overall is required to be melted.

The present invention also relates to a device for joining a first component to a second component using energy beam welding, at least one of the components having a coating that evaporates in some areas during the energy beam welding dissolved. The device is equipped with one first and one second pressure piece, between which the first and the second component may be positioned, a drive unit with the aid of which the pressure pieces are moved toward one another, an analysis unit with the aid of which a curve that characterizes the force occurring between the pressure pieces may be analyzed, a control unit with the aid of which the drive unit may be activated for setting a relative position of the pressure pieces with respect to one another as a function of an analysis of the curve by the analysis unit, and a joining device for generating an energy beam for joining the components in the relative position. Alternatively and/or in addition, the device is configured, constructed, designed and/or equipped with a software for carrying out a method as described above. The results are the advantages described above.

Further advantages, features and details result from the following description in which an exemplary embodiment is described in detail with reference to the drawing. Identical, similar and/or functionally identical parts are denoted by the same reference numerals.

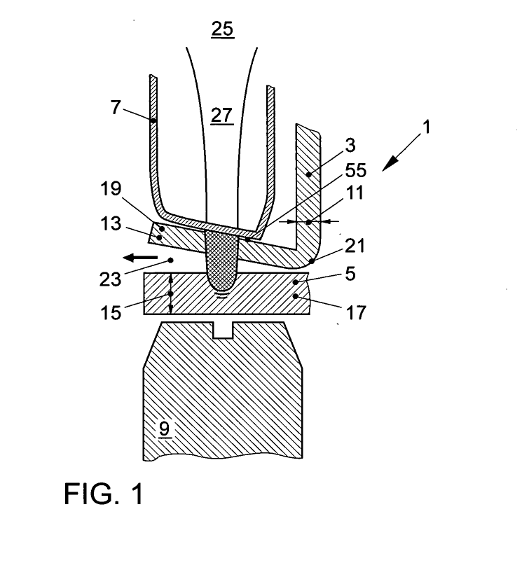

FIG. 1 schematically shows a sectional view of a partially depicted device for joining components using energy beam welding;

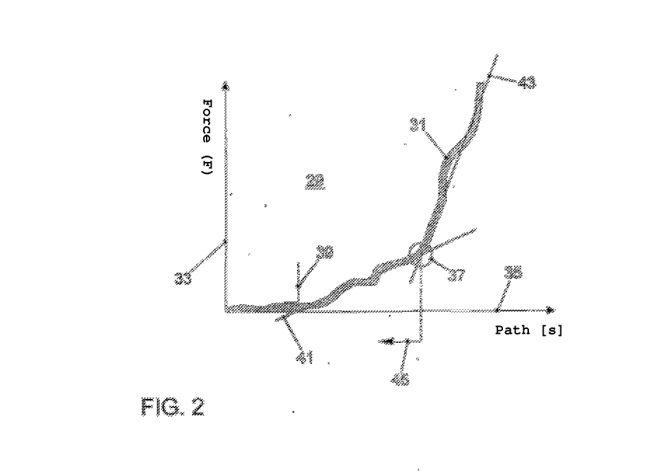

FIG. 2 shows a force-path diagram of a welding process which may be carried out using the device represented in FIG. 1; and

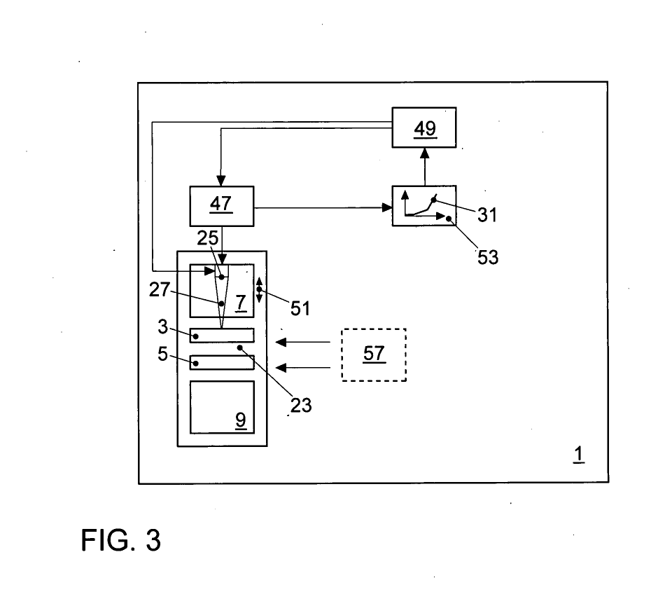

FIG. 3 shows a block diagram of a control loop for controlling the device shown in FIG. 1.

FIG. 1 shows a schematic sectional view of a device 1 for joining a first component 3 to a second component 5. Device 1 is only partially depicted in FIG. 1.

At least one of components 3 and 5 has a coating not represented in further detail. The coating is made preferably of zinc, components 3 and 5 preferably being made of a metal plate, in particular a steel sheet. To join components 3 and 5 requires melting a core material of components 3 and 5, in particular steel, an evaporation of the coating, for example, zinc, occurring.

In the representation as seen in FIG. 1, first component 3 and second component 5 are situated between a first pressure piece 7 and a second pressure piece 9. Second pressure piece 9 is designed as a fixed pressure piece and first pressure piece 7 as a movable pressure piece. By moving first pressure piece 7 accordingly, both may be moved either toward or away from one another, first component 3 and second component 5 thus being positionable relative to one another. First pressure piece 7 may be moved upward or downward in the direction as seen in FIG. 1 by a drive unit not further depicted, for example an electric motor drive, for example, a linear electric motor drive.

First component 3 has a first thickness 11 t₁ and a first heat transfer resistance 13 Rₘ₁. Second component 5 has a second thickness 15 t₂ and a second heat transfer resistance 17 Rₘ₂. The inequations −t₁≦t₂ and −Rₘ₁≦Rₘ₂ apply.

First component 3 has a welding flange 19 which transitions at an acute angle at a bend 21 to the remainder of first component 3. Arising between first component 3 and second component 5 is a joint gap 23 opening conically outward from bend 21. In the representation seen in FIG. 1 pressure pieces 7 and 9 are moved close enough to one another such that a defined geometry of joint gap 23 is set under a semi-elastic deformation of welding flange 19, in particular, in the area of bend 21 and with bend 21 of first component 3 contacting a corresponding surface of second component 5, an opening at an outlet of joint gap 23 measuring approximately 0.25 mm, a length of joint gap 23 measuring approximately 10 mm. Furthermore, an overall plate thickness of first component 3 and second component 5 measures approximately 5-7 mm.

Device 1 includes a beam source 25 not further shown in FIG. 1 for generating an energy beam 27. Energy beam 27 is preferably a laser beam. First pressure piece 7 is hollow in design, energy beam 27 being conducted through an interior of first pressure piece 7 and exiting therefrom through an opening, energy beam 27 striking first component 3.

Device 1 includes a drive unit 47 not further shown for adjusting first pressure piece 7; it is alternatively and/or in addition equipped with a positioning control, also known as a tong stroke control.

FIG. 2 shows a diagram 29 of a curve 31 of a force 33 plotted on a y-axis of diagram 29 over a path 35 plotted on an x-axis of diagram 29. Path 35 is a movement of first pressure piece 7 relative to fixed second pressure piece 9 of device 1 shown in FIG. 1. Force 33 is the force that occurs between pressure pieces 7 and 9, the force being transferred via or acting on first component 3 and second component 5 when the two components are in contact. It may be seen that curve 31 includes two bends or points of slope change, namely a point of slope change 37 and a second point of slope change 39. Second point of slope change 39 occurs after a more or less horizontal section of curve 31. This corresponds to a more or less unforced movement of first pressure piece 7 in the direction of components 3 and 5, the two not yet being in contact. At second point of slope change 39 components 3 and 5 start to come into contact in the area of bend 21. Starting from second point of slope change 39, curve 31 rises at a first slope that corresponds to an at least semi-elastic deformation of welding flange 19. At this point joint gap 23 extending conically is closed, that is, welding flange 19 is moved toward the surface of second component 5. The approach continues until welding flange 19 rests surface-to-surface or flat on the surface of second component 5 in such a way that joint gap 23 transitions precisely during the approach into a zero joint gap. In this, a second relative position of pressure pieces 7 and 9 with respect to one another, that is, when the zero joint gap is present, point of slope change 37 occurs, curve 31 exhibiting an even steeper slope beyond point of slope change 37.

Point of slope change 37, that of the second relative position of pressure pieces 7 and 9 just reached with respect to one another, in which the zero joint gap of joint gap 23 has just occurred, may be advantageously ascertained by applying a first tangent 41 and a second tangent 43. First tangent 41 is applied to curve 31 between point of slope changes 37 and 39. This may be accomplished, for example, by using a regression method. Second tangent 43 is applied beyond point of slope change 37 to curve 31, for example, also by using a regression method. Point of slope change 37 advantageously results as the point of intersection of first tangent 41 with second tangent 43.

Alternatively and/or in addition, second point of slope change 39 may also be ascertained. This may be accomplished by determining a point of intersection of first tangent 41 with the x-axis of diagram 29 that includes path 35. In so doing, it may be assumed that the displacement of first pressure piece 7 is more or less unforced up to second point of slope change 39.

Advantageously, starting from point of slope change 37 or from the underlying second relative position of pressure pieces 7 and 9 with respect to one another, that is, starting from the zero joint gap of joint gap 23, first pressure piece 7 may be moved by a defined value 45 far enough away again from second pressure piece 9 until pressure pieces 7, 9 assume a relative position required for joining. Advantageously, joint gap 23 opens in this process, thereby creating the conical curve of joint gap 23, welding flange 19 thereby resting against first pressure piece 7 as a result of restoring forces. Value 45 amounts approximately to a restoring path of first pressure piece 7 of 0.2 mm, in particular 0.15-0.25 mm, in particular 0.1-0.3 mm, in particular 0.1-0.4 mm, in particular 0.05-0.5 mm.

FIG. 3 shows a block diagram of a control and/or regulation of device 1 shown in FIG. 1. Identical and/or functionally identical components are denoted by the same reference numerals, so that only the differences will be discussed.

Device 1 includes a drive unit 47 which acts on first pressure piece 7. Drive unit 47 may be used to move first pressure piece 7 toward or away from second pressure piece 9. Drive unit 47 is connected upstream of a control unit 49, an auxiliary energy source for operating drive unit 47 being omitted from FIG. 3 for the purpose of simplification. Control unit 49 is also connected upstream of beam source 25 for generating energy beam 27. The process of joining components 3 and 5 may be controlled with the aid of control unit 49. Control unit 49 also includes a tong stroke control not shown in further detail, for example, a servo control which interacts with drive unit 47 for adjusting first pressure piece 7.

An adjustment movement of first pressure piece 7 is symbolized in FIG. 3 by a double arrow 51. Advantageously, curve 31 of the movement symbolized by double arrow 51 may be analyzed with the aid of analysis unit 53. Analysis unit 53 is connected downstream of drive unit 47 and upstream of control unit 49. As described above, control unit 49 controls the relative position of pressure pieces 7 and 9 with respect to one another, for which defined value 45 is set. For this purpose, pressure pieces 7 and 9 are initially moved beyond second point of slope change 39 and at least as far as point of slope change 37 or, if necessary, beyond this point, then moved back and, starting from point of slope change 37, that is, from the second relative position, back to the relative position advantageous for the joining process. Thus, during an advance, the actual relative position to be set is surpassed. The second relative position is then reached or, if necessary, also surpassed. Then in a backward movement the second relative position in the opposite direction is again surpassed if necessary, or the backward movement is initiated from this point in order to thereby reach the relative position to be set with the backward movement starting from the second relative movement.

With the aid of drive unit 47, designed for example, as an electric motor-driven clamping unit, in particular analogous to an electric motor-driven upper and/or lower arm of resistance spot welding tongs, both components 3 and 5 may be designed as mating parts, components 3 and 5 being designed, for example, as galvanized metal sheets, and may be lap welded together with a high degree of quality and advantageously without the use of a mechanical spacer. In this process, components 3 and 5 to be welded are first positioned, in particular clamped, without force between first pressure piece 7 and second pressure piece 9. This can be accomplished, for example, with an adaptive position >0.1 mm, greater than the overall thickness to be joined, or sheet pairing thickness of components 3 and 5.

Alternatively and/or in addition, it is conceivable to thus set and/or determine said adaptive position >0.1 by ascertaining with the aid of analysis unit 53 just the second point of slope change 39. In this case, the mating members, that is, components 3 and 5, are already positioned against one another at the second point of slope change with the zero gap of joint gap 23. In this case, the welding flange may be designed correspondingly parallel to second component 5 so that the at least semi-elastic deformation is eliminated. From this point, first pressure piece 7 is then pulled back, it being unnecessary for first component 3 to also be moved back in the process. Energy beam 27 may then be advantageously focused on components 3 and 5 so inserted. This advantageously creates a laser molten pool with a blow effect or a vapor pressure of the coating evaporating as a result of the molten pool, which advantageously forces components 3 and 5 apart in such a way that they are reliably positioned against pressure pieces 7 and 9, as a result of which the adaptive position and thereby joint gap 23 provided with value 45 is advantageously set. Joint gap 23 then advantageously corresponds to the distance between pressure pieces 7 and 9 which exceeds the thickness of the sheet pair to be joined.

Alternatively and/or in addition, bend 21 may include the acute angle so that initially the at least semi-elastic deformation of welding flange 19 occurs, such that therefore point of slope change 37 and second point of slope change 39 appear or are ascertainable in curve 31. Advantageously resulting from this is joint gap 23 opening conically on one side outward from bend 21. The joint gap is sufficiently proven to ensure degassing for enabling a solid weld connection.

Alternatively and/or in addition, welding flange 19 may have an angular placement under the defined pre-stresses, which may be produced by a chamfer 55 of first pressure piece 7. This makes it advantageously possible, alternatively or in addition, to produce an adaptation of a geometric form of the first pressure piece to the gap shape of joint gap 23 to be produced, that is, the shape opened on one side.

According to the regulation and/or control shown in FIG. 3 for finding a precise clamping position of components 3 and 5 between pressure pieces 7 and 9, first pressure piece 7 initially closes, and is therefore moved closer to second pressure piece 9. In the process, curve 31 of force-path diagram 29 shown in FIG. 2 is recorded with the aid of analysis unit 53. Once first pressure piece 7 comes into contact with first component 3 and/or bend 21 of first component 3, force transmittingly abuts second component 5, then force 33 increases starting from the second point of slope change 39. Once components 3 and 5 rest flush against one another, that is, with the zero gap of joint gap 23, force 33 increases more sharply, which is the case beyond or starting from point of slope change 37. By applying tangents 41 and 43 to curve 31, which represents, in particular, a measuring curve, and by determining the point of intersection of tangents 41 and 43, it is advantageously possible to determine a point characteristic of different thicknesses 11 and 15 of components 3 and 5, on the basis of which the defined gap situation for the controlled and safe welding of different sheet thickness combinations may be achieved by a slight opening of pressure pieces 7 and 9, which are, for example, elements of a pair of clamping tongs. The slight opening occurs with value 45.

Advantageously, it is not necessary to store or program a joint gap-dependent plate thickness value 11, 15 of components 3, 5 in control unit 49 of device 1. A mechanization 57 represented by dashed lines in FIG. 3 may be optionally provided for inserting and removing components 3, 5.

### LIST OF REFERENCE NUMERALS

1 device
3 first component
5 second component
7 first pressure piece
9 second pressure piece
11 first thickness
13 first heat transfer resistance
15 second thickness
17 second heat transfer resistance
19 welding flange
21 bend
23 joint gap
25 beam source
27 energy beam
29 diagram
31 curve
33 force
35 path
37 point of slope change
39 point of slope change
41 tangent
43 tangent
45 value
47 drive unit
49 control unit
51 double arrow
53 analysis unit
55 chamfer
57 mechanization

1. A method for joining a first component to a second component using energy beam welding, at least one of the components having a coating that evaporates in some areas during the energy beam welding, including:
positioning the first component and the second component between a first pressure piece and a second pressure piece,
moving the pressure pieces toward one another and in the process
analyzing a curve which characterizes a force that occurs between the pressure pieces,
setting a relative position of the pressure pieces with respect to one another as a function of the analysis, and
joining the components using energy beam welding with the pressure pieces in the set relative position.

2. The method of claim 1, including:
ascertaining through analysis a point of slope change in the curve, and
setting a relative position by moving the pressure pieces by a defined value and based on a second relative position of the pressure pieces with respect to one another at which the point of slope change in the curve occurs.

3. The method of claim 1, including:
positioning the components on the respective pressure piece with the aid of a vapor pressure from evaporation of the coating that occurs in some areas during the energy beam welding.

4. The method of claim 1, wherein one of the components has a welding flange including:
bringing the components into contact at a bend of the welding flange, and
producing, between the components a joint gap opening conically outward from the bend,
closing the joint gap under at least semi-elastic deformation of the welding flange by moving the pressure pieces toward one another, the ascertained point of slope change occurring just as the joint gap closes, and
defined opening of the joint gap by setting the relative position.

5. The method of claim 1, including:
pre-stressing the first component with the aid of a chamfer of the first pressure piece.

6. The method of claim 1, including:
ascertaining the curve as a force-path diagram of the pressure pieces.

7. A device as recited in claim 1, including at least one of the following:
ascertaining a second point of slope change which occurs when the components begin to make contact at the bend of the welding flange,
applying two tangents to the curve, and
ascertaining the point of slope change as a point of intersection of the tangents.

8. The method of claim 1, including:
moving the pressure pieces apart by the defined value of at least one of the following intervals: 0.05-0.5 mm; 0.1-0.4 mm, 0.1-0.3 mm, 0.15-0.25 mm, preferably 0.2 mm.

9. The method of claim 1, wherein a first thickness and/or a first heat transfer resistance of the first component is/are smaller than a second thickness and/or a second heat transfer resistance of the second component, including:
focusing an energy beam on a back side of the first component for joining the component.

10. A device for joining a first component to a second component using energy beam welding, at least one of the components having a coating that evaporates in some areas during the energy beam welding, including:
a first and a second pressure piece between which the first and the second component may be positioned,
a drive unit, with the aid of which the pressure pieces may be moved toward one another,
an analysis unit, with the aid of which a curve that characterizes a force occurring between the pressure pieces may be analyzed, and
a control unit, with the aid of which the drive unit may be actuated for setting a relative position of the pressure pieces with respect to one another as a function of the analysis of the curve by the analysis unit.
